(19) United States
(12) Patent Application Publication
(10) Pub. No.: US 2006/0089182 A1
(43) Pub. Date: Apr. 27, 2006

(54) Elastomeric tensioner and mobile stations using same

(75) Inventor: Andrew Julian Gartrell, Tarzana, CA (US)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Nokia Corporation

(21) Appl. No.: 10/970,178

(22) Filed: Oct. 21, 2004

(51) Int. Cl. H04M 1/00

(52) U.S. Cl. 455/575.3

(57) ABSTRACT

The present invention provides an improved hinge design for a mobile station or other electronic device that simplifies hinge assembly and thus, provides a more cost-effective manufactured product. Moreover, the improved hinge assembly complements the aesthetic appeal of the foldable mobile station and provides less stress on various internal elements. In particular, the present invention includes a foldable mobile station or other foldable electronic device having a first functional component coupled to a second functional component via an elastomeric tensioner. The elastomeric tensioner functions to bias the first and second functional components in either an open or folded position.

### FIELD OF THE INVENTION

The present invention relates generally to mobile stations, and more specifically to a mobile station having a folded design encompassing an elastomeric tensioner.

### BACKGROUND

The manufacture and design of today's mobile stations (also known as mobile phones, PDAs, pagers, laptop computers and the like) are constantly evolving. Early mobile station designs were necessarily large and bulky. The radio communications equipment and battery units necessary for their operation generally were carried in one oversized unit; although in at least one early and cumbersome design the unit was actually divided into two pieces which were then connected by a power cable. Advances in integrated circuitry and electricity storage technology have enabled mobile station designers to create smaller and smaller devices. These instruments are not only lighter, but also less cumbersome and easier to transport. For example, mobile stations are no longer required to be permanently installed in automobiles or connected to bulky separately-carried battery packs. Essentially, today's smaller, more useful mobile stations have simply become more fashionable.

Unfortunately, several drawbacks have followed this new fashionability and convenience. For example, the increased mobility of today's mobile stations has the unintended drawback of subjecting these mobile stations to an ever-increasing number of potentially damaging environments. For modern day consumers, these environments include pockets, briefcases, purses, gym bags, glove compartments and toolboxes where the mobile station can contact harmful solid objects and moisture that may cause structural and/or cosmetic damage to the relatively delicate internal and operational elements (e.g., LCD displays, microphone and speaker ports, keypads, etc.) of the mobile station. Accordingly, mobile stations are highly susceptible to damage. To make matters worse, market forces continue to drive mobile stations smaller, therefore, making it more difficult to add bulky structural reinforcements that might protect the mobile stations.

This risk of damage is exacerbated by the number of externally accessible components that are provided on modern mobile stations. One of the most prominent of these components is the visual display. Initially, such displays were limited to small, light emitting diodes (LEDs) that indicated whether the mobile station was “on” or, regarding mobile phones, whether a call was in progress. Gradually, more advanced LED displays were developed that were capable of displaying a dialed telephone number, the current time, or other simple information. More recently, liquid crystal displays (LCDs) have become commonplace. An LCD is made by sandwiching an electrically sensitive liquid-crystal material between two very thin pieces of glass or other transparent materials. They are, therefore, easily susceptible to damage by even a relatively minor impact. Despite the hard, transparent cover or similar protective device, generally added to limit this vulnerability, LCDs remain one of the most easily damaged components in modern mobile stations.

The folded mobile station design has developed, in part, to provide greater durability to modern mobile stations. As will become apparent, folded mobile stations also provide increased utility due to their relatively compact size. A folded mobile station is one that may be, generally speaking, folded from two parts into one more compact part. More specifically, as illustrated in FIGS. 1A-1C, folded mobile stations 100 are generally comprised of a first functional component 101 and a second functional component 102. The first and second functional components 101, 102 are mechanically coupled to one another by a hinge assembly 175 such that each may be folded over the other in a clam-shell type action. Accordingly, folded mobile stations 100 possess an “open” and a folded or “closed” position.

FIG. 1A provides one example of a conventional mobile station 100 (a mobile phone) oriented in the open position. As known to one of ordinary skill in the art, the first and second functional components 101, 102 of the mobile station 100 include various internal circuitry and operational elements. For example, the first functional component 101 is depicted as including a LCD 150. The LCD 150 is visible through, and protected by, a clear plastic cover 151. A speaker port 154 is comprised of a series of small openings formed in the first functional component 101 adjacent to an internal speaker (not shown). The first functional component 101 also typically includes circuitry for driving the LCD 150 and internal speaker (not shown).

The second functional component 102 of a conventional mobile station 100 generally includes a microphone port 155 that is adjacent to an internal microphone (not shown). A keypad 160 is also provided that is comprised of a series of keys extending through a plurality of openings from an otherwise internally disposed key mat. As with the first functional component 101, the second functional component 102 also houses the internal circuitry associated with the above described microphone 155 and keypad 160. An antenna for facilitating radio frequency (RF) communications (not shown) may be located in either the first functional component 101 or the second functional component 102, or may be distributed between them. Mobile station batteries (not shown) are typically stored in the second functional component 102, due to the limited space available in the first functional component 101 as a result of the LCD 150 and speaker 154 placement. An external power supply (not shown), such as an AC adaptor, may be connected through a power port 144. Similarly, external headphones (not shown) may be connected to the mobile station 100 at the external-device port 145.

When the mobile station is “opened,” the user has access to the keypad 160 and can conveniently place the speaker port 154 and microphone port 155 in a position for voice communication. The mobile station 100 may also be “closed” by folding the first portion 101 to meet the second portion 102 in a clam-shell action as indicated by the arrow. FIG. 1B illustrates a known mobile station 100 in the closed position. Advantageously, the first functional component 101 and the second functional component 102 close in such a manner as to protect the keypad 160 and LCD 150. In various applications, mobile stations 100 may be operable in a closed configuration by employing an external microphone, speaker, or display (not shown). Such devices are often used in ‘hands-free’ operation, and are readily connected through an external-device port 145. As alluded to above, the folded design of modern mobile stations 100 is distinguishable over predecessors by accommodating safe storage on belts, in pockets, purses, or glove compartments without subjecting the sensitive internal components to damage from keys or other objects frequently encountered in such environments.

As should by now be apparent, folded mobile stations 100 possess features that are both useful and desirable to consumers. In addition to the durability and size improvements discussed above, many users prefer the aesthetics of folding designs over others. Despite the above improvements, the conventional folding mobile station design depicted in FIGS. 1A and 1B is still not optimal. For example, conventional folding mobile stations 100 use a cylindrical hinge assembly 175 similar to a standard door hinge to bind the first functional component 101 to the second functional component 102. As illustrated in FIG. 1C, this hinge assembly 175 is relatively complex and more importantly, requires highly labor-intensive assembly operations and thus, is costly to manufacture.

In particular, conventional hinge assemblies 175 are comprised of hinge members 176, 177 and 181 that extend from the first functional component 101, and hinge members 178 and 179 that extend from the second functional component 102. These hinge members 175-179 and 181 are held together by a hinge pin 180 that extends through openings (not shown) formed in each hinge member. During assembly, the hinge pin 180 must be carefully inserted through the openings provided in the hinge members 175-179 and 181, and also must be threaded through a pre-assembled spring 182, a profile indent part (dynamic) 183, and a profile indent part (static) 184 as shown in FIG. 1C. These latter components are provided to maintain the mobile station 100 in either an open or closed position as known to one of ordinary skill in the art. Finally, a flexible printed circuit or cable bundle 185 must be awkwardly wrapped around the pin 180 to ensure that the first functional component 101 is electrically connected to the second functional component 102.

As will be apparent to one of ordinary skill in the art, the complexity of the above hinge design results in cost-prohibitive and bulky hinge assemblies. For example, the above hinge assembly requires precision elements, high part counts, and relatively long assembly times that all add to the manufactured cost. In addition, the complex prior art hinge designs hinder the ability of designers to make stylish modifications. In light of the foregoing, it would be highly desirable to provide an improved hinge design for a foldable mobile station that is relatively simple to assemble and compliments the overall aesthetic appeal of the mobile station. Furthermore, it would be desirable to provide a hinge design that maintains the durability and size benefits realized by the development of modern foldable mobile stations.

### BRIEF SUMMARY OF THE INVENTION

The present invention provides an improved hinge design for a mobile station, such as a mobile phone or other foldable electronic device. The improved design simplifies hinge assembly and provides a more cost-effective manufactured product. Moreover, the improved hinge design complements the aesthetic appeal of the foldable mobile station and results in less applied stress on various internal elements.

Mobile stations and other foldable electronic devices include first and second functional components that are pivotally coupled together via a hinge. In various embodiments, the first and second functional components may be first and second halves of a mobile phone, the first and second portions of a laptop computer, or other similar foldable mobile station parts as apparent to one of ordinary skill in the art. The first and second functional components include various operational elements such as a display, a speaker, a microphone, one or more battery elements, assorted internal electronic circuitry and the like. One or more operational elements may be positioned adjacent either the first or second functional components depending upon the application. Accordingly, the first and second functional components are electrically connected together to support the operational elements. As discussed above, the operational elements are protected from external impact and other environmental hazards by simply closing or folding the mobile station.

In several embodiments of the present invention, the first and second functional components are biased between open and folded positions by an elastomeric tensioner. In various embodiments, the elastomeric tensioner may include a ring-shaped band that at least partially encloses the hinge region of a mobile station, opposing C-shaped bands also at least partially enclosing the mobile station hinge, one or more axially extending elastic members having a bi-stable lobe formed adjacent the mobile station hinge, and a foldable body having at least one bi-stable lobe formed adjacent the hinge region of the mobile station. The elastomeric tensioners may be produced from any elastic and/or resilient material such as rubber, polymer materials, composites, spring steels, metals and the like. In several embodiments, one or more couplers such as rivets, pop-studs, adhesives, tongue and groove type structures and the like may be provided to fasten the elastomeric tensioner to the exterior surface of the first and second functional components.

In one embodiment, the elastomeric tensioner is a ring-shaped band that is formed to at least partially enclose the hinge region of a mobile station. The first and second functional components are foldably coupled to define an operating angle therebetween that is configurable between an open angle, a flip angle, and a folded angle. In one embodiment, the ring-shaped band applies a folding tension to the exterior surface of the first and second functional components when the operating angle is between the flip angle and the folded angle. In another embodiment, the ring-shaped band applies an opening tension to the first and second functional components when the operating angle is between the flip angle and the open angle. Accordingly, the mobile station is biased between open and folded positions.

In another embodiment, the elastomeric tensioner comprises two opposed C-shaped bands. The opposed C-shaped bands at least partially enclose the first and second components of the mobile station adjacent its hinge region. The first and second functional components are foldably coupled to define an operating angle therebetween that is configurable between an open angle, a flip angle, and a folded angle. In one embodiment, the opposed C-shaped bands apply a folding tension to the first and second functional components when the operating angle is between the flip angle and the folded angle. In another embodiment, the opposed C-shaped bands apply an opening tension to the first and second functional components when the operating angle is between the flip angle and the open angle. Accordingly, the mobile station is biased between open and folded positions.

Other embodiments of the present invention replace the above generally transversely-aligned ring-like bands with substantially axially-aligned bi-stable lobes. For example, in one embodiment, the elastomeric tensioner includes one or more axially-aligned, laterally attached, elastic members comprising opposed bi-stable lobes formed on either side of the hinge region of a mobile station. In the folded position, the bi-stable lobe is configured to maintain a compact, substantially conical shape that functions to generally maintain the attached first and second functional components together. When opened, the bi-stable lobes deform inside-out to produce an extended relatively flattened shape that functions to generally maintain the attached first and second components apart. The bi-stable lobes apply a tension force to the mobile station depending on its position. For example, as described above, the bi-stable lobes apply a folding tension to the first and second functional components between the folded position and the flip position and apply an opening tension to the first and second functional components between the flip position and the open position. In yet another embodiment, the bi-stable lobes of the elastomeric tensioner are configured to provide a tactile gripping surface for a user to manipulate the mobile station.

These and other features, aspects, and advantages of embodiments of the present invention will become apparent with reference to the following description in conjunction with the accompanying drawings. It is to be understood however, that the drawings are designed solely for the purposes of illustration and not as a definition of the limits of the invention.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIGS. 1A, 1B, and 1C are views of one example of a conventional foldable mobile station (i.e., mobile phone) according to the known prior art; wherein FIG. 1A is a perspective view of the mobile station in an open configuration, FIG. 1B is a perspective view of the mobile station in a folded configuration, and FIG. 1C is a section view of the conventional cylindrical hinge assembly depicted in FIGS. 1A and 1B according to the known prior art;

FIG. 2 is a perspective view of a mobile station placed in an “opened” position in accordance with one embodiment of the present invention;

FIG. 3 illustrates a rear perspective view of the opened mobile station depicted in FIG. 2;

FIG. 4 depicts a perspective view of the mobile station of FIG. 2 configured in a “folded” position according to one embodiment of the present invention;

FIG. 5A depicts a side view of the folded mobile station of FIG. 4;

FIG. 5B depicts a section view of a folded mobile station according to another embodiment of the invention;

FIG. 6A is a side view of a folded mobile station having an elastomeric tensioner in accordance with one embodiment of the present invention;

FIG. 6B is a detail view of the elastomeric tensioner depicted in FIG. 6A;

FIG. 7A is a side view of an opened mobile station having an elastomeric tensioner in accordance with one embodiment of the present invention;

FIG. 7B is a detail view of the elastomeric tensioner depicted in FIG. 7A;

FIG. 8A is a schematic illustration of the movement of elastomeric tensioner connection points “C” relative to hinge point “H”, as the folded mobile station of FIG. 6A is configured into the open position depicted in FIG. 7A;

FIG. 8B is a simplified schematic illustration of the relative closing and opening moments produced by several elastomeric tensioner embodiments as the mobile station is configured on either side of flip point “FP”;

FIG. 9 is an exploded view of mobile station in accordance with one embodiment of the present invention;

FIGS. 10A, 10B and 10C are perspective views of user interface members in accordance with various embodiments of the present invention; wherein FIG. 10A is a perspective view of a “hingeless” user interface member, FIG. 10B is a perspective view of an interface member having a “book-style” hinge, and FIG. 10C is a perspective view of a user interface member having a “piano-style” hinge;

FIGS. 11A and 11B are perspective views of a folded mobile station having an elastomeric tensioner comprising opposed C-shaped bands in accordance with various embodiments of the present invention; wherein FIG. 11A is a front perspective view, and FIG. 11B is a side perspective view;

FIG. 12A is a perspective view of the mobile station of FIGS. 11A and 11B, configured in the open position;

FIG. 12B is a schematic illustration of the tension forces produced by the elastomeric tensioner embodiment of FIG. 12A, as the mobile station transitions between open and folded configurations;

FIGS. 13A, and 13B are views of a foldable body having an integral elastomeric tensioner in accordance with one embodiment of the present invention; wherein FIG. 13A is a perspective view the foldable body, and FIG. 13B is a section view of the foldable body, taken along section lines 13B-13B; and

FIGS. 14A, 14B are views of an opened foldable member having an integral elastomeric tensioner in accordance with one embodiment of the present invention; wherein FIG. 14A is a front view of the opened foldable member, and FIG. 14B is a section view of the opened foldable member of FIG. 14A, taken along section lines 14B-14B.

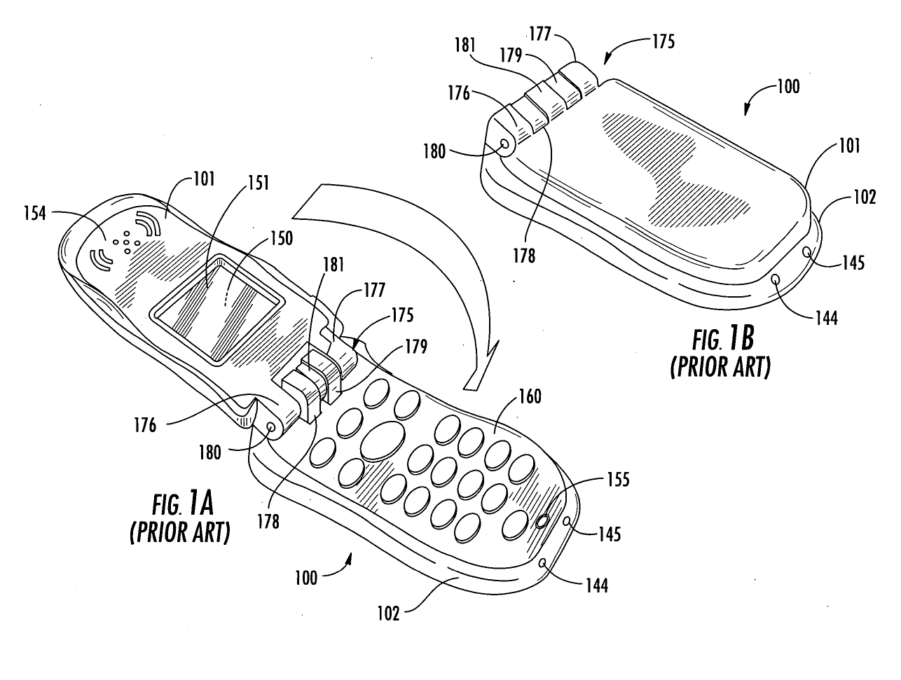

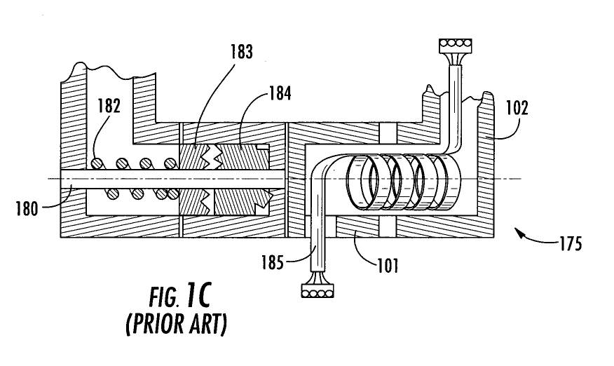

### DETAILED DESCRIPTION OF THE INVENTION

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

The present invention is directed to a mobile station having an elastomeric tensioner for biasing the mobile station between open and folded positions. For purposes of the present application and appended claims, the term elastomeric or elastomer refers to a polymer, rubber, or other similar material having elastic and resilient properties. One type of elastomeric tensioner is illustrated in co-pending, commonly owned, International Application No. PCT/US2003/026961 (“the '961 application”) filed Aug. 28, 2003, which is incorporated herein by reference. The '961 application is directed, at least in part, to a mobile station that is biased between open and folded positions by an elastomeric band that is held in grooves or captured by extensions formed around the perimeter of the mobile station. The present invention is directed generally to alternate elastomeric tensioner embodiments as described in detail below.

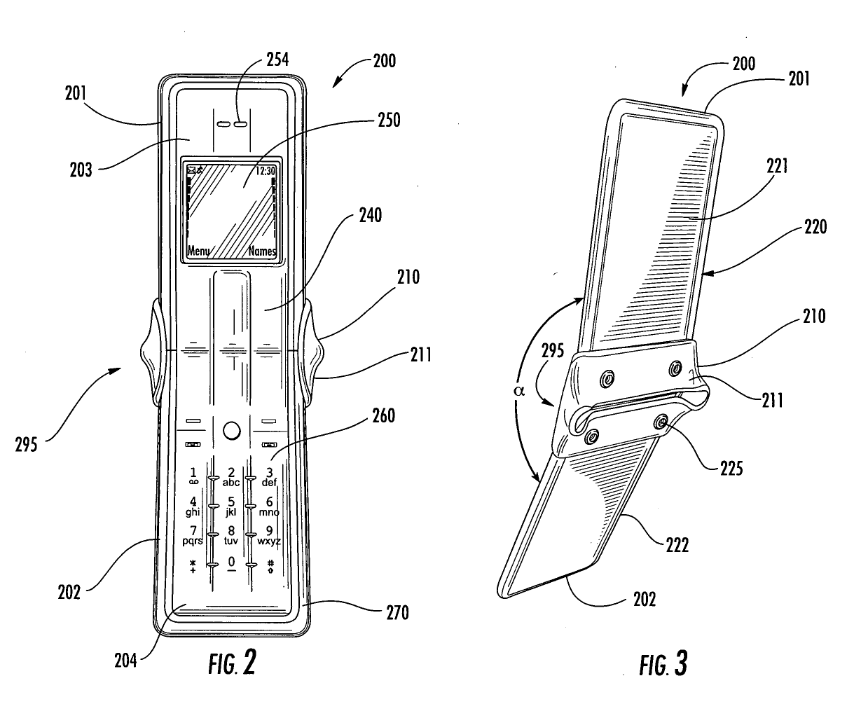

FIG. 2 illustrates a perspective view of an “opened” mobile station 200 in accordance with one embodiment of the present invention. Although a mobile phone application has been selected for illustration in the several figures, the present invention is not limited to such an embodiment. In fact, for the purposes of the following specification and appended claims, the term “mobile station” refers to mobile phones, PDAs, pagers, calculators, laptop computers, and other similar foldable electronic devices as commonly known in the art.

The mobile station 200 of FIG. 2 is comprised of a first functional component 201 that is coupled in foldable relation to a second functional component 202. In particular, the first and second functional components 201, 202 are folded about a hinge region 295 in a clam-shell fashion (i.e., one atop the next) as described above. To better illustrate the structure and orientation of various mobile station components, the following specification and appended claims refer to an axial direction defined generally along the length of an opened mobile station (from top to bottom as shown in FIG. 2) and, alternatively, refer to a transverse or lateral direction that is defined substantially perpendicular to the axial direction, i.e., from side to side.

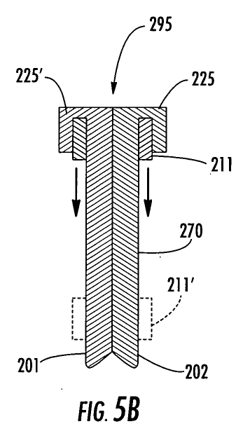

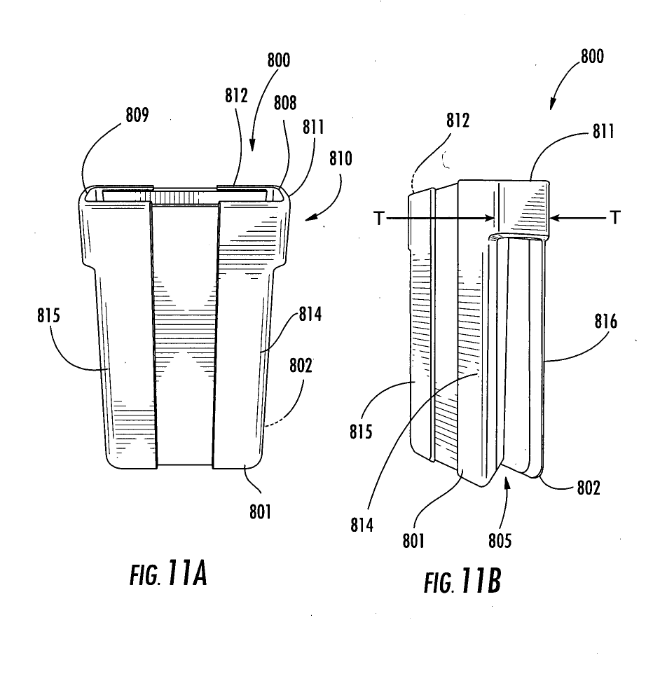

The first and second functional components 201, 202 of the mobile station 200 include respective first and second inner surfaces 203, 204. In one embodiment, the first and second inner surfaces 203, 204 are integrally formed within a unitary user interface member 240 as shown. In other embodiments, the user interface member 240 may be separated into two parts and hinged, as discussed below in reference to FIGS. 10A-10C. In several embodiments of the present invention, a plurality of relatively delicate operational elements (e.g., a display 250, a keypad 260, a speaker port 254, a microphone port 255, etc.) are disposed on or integral to the first and second inner surfaces 203, 204 of the user interface member 240. Accordingly, as the mobile station 200 is configured in the folded position (shown in FIGS. 4 and 5) the plurality of operational elements are protected from potentially damaging impacts and other contact with foreign substances. Although FIG. 2 depicts certain operational elements adjacent either the first or second inner surfaces 203, 204 of the user interface member 240, it is important to note that the present invention is not limited to the depicted configuration and, in fact, various operational elements may be disposed adjacent either the first or second functional components 201, 202 as known in the art.

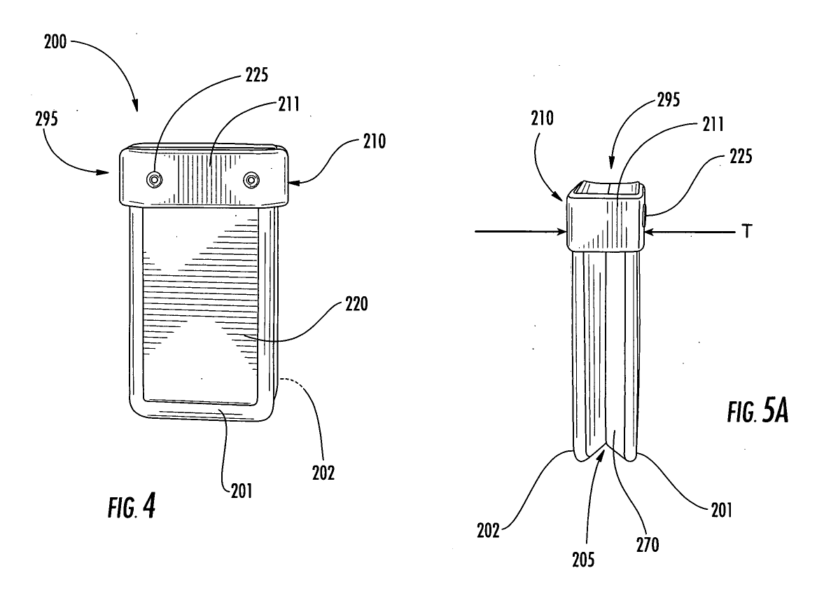

During use, it is desirable for the mobile station 200 to remain open such that a user may access the variety of operational elements. During non-use, it is desirable for the mobile station 200 to remain folded such that the operational elements are protected from damage. According to various embodiments of the present invention, an elastomeric tensioner 210 is provided to bias the first and second functional components 201, 202 between open and folded positions. In the open position, the first and second functional components 201, 202 of the mobile station 200 are spaced apart to define an operation angle α illustrated in FIG. 3. Depending upon the particular application, this operation angle α provides a user access to the operational elements of the mobile station 200 and, thus, may vary considerably. For example, in mobile phone applications the operation angle may be between 150° and 180°, while in other applications (e.g., laptop computers) the preferred operation angle α may be considerably less.

In various embodiments, as illustrated in FIGS. 2-5, the elastomeric tensioner 210 includes a single elastic band 211. In other embodiments, two or more elastic bands 211 may be provided. The elastic bands 211 may be comprised, at least partially, of rubber, polymers, composites or other similar elastic and resilient materials capable of applying tension forces as described below. The elastic bands 211 may be comprised of a single material or multiple rigid and/or pliable materials as will be apparent to one of ordinary skill in the art. In various embodiments, the elastic bands 211 may form a continuous ring as shown or, alternatively, the bands 211 may define one or more discontinuities. For example, the bands 211 may define apertures, holes or pockets to provide clearance for various mobile station components, to reduce material costs, or to achieve other similar design goals as known in the art.

In the depicted embodiment, the elastomeric tensioner 210 is an elastic ribbon or ring-shaped band 211 having a width that is greater than its thickness. The utility of this configuration will become apparent in view of the following discussion of the band's tensioning functionality. The ring-shaped band 211 is preferably attached adjacent the exterior surfaces of the first and second functional components 201, 202 of the mobile station 200. In one embodiment, as illustrated in FIG. 3, the ring-shaped band 211 is coupled to an exterior cover 220 that is disposed over the exterior surfaces of the first and second functional components 201, 202. The exterior cover 220, in combination with a body member 270 (depicted in greater detail by FIG. 5A), protect the delicate electrical circuitry disposed within the first and second functional components 201, 202.

Referring to FIGS. 4 and 5A collectively, in one embodiment the ring-shaped band 211 is formed to fit snugly around at least a portion of the hinge region 295 of the folded mobile station 200 as shown. As referenced above, the hinge region 295 is the region adjacent the foldable intersection of the first and second functional components 201, 202. In the depicted embodiment, the ring-shaped band 211 is maintained adjacent the exterior cover 220 and/or body member 270 by two or more couplers 225. The couplers 225 are structured such that the ring-shaped band 211 is prevented from sliding off of the mobile station 200 as it transitions between open and folded configurations. In various embodiments, the couplers 225 may be rivets as shown, or alternatively, may include screws, nails, tongue and groove-type mechanical junctions, adhesives and other similar means.

In one embodiment, as shown in FIG. 5B, the couplers may be one or more hooks or L-shaped flanges 225′ that extend outwardly from the exterior cover 220 and/or body member 270 of the mobile station. The flanges 225′ capture the ring-shaped band 211 and prevent the band from sliding over the hinge region 295 of the mobile station when opened. In another embodiment, the flanges 225′ may be slideable along the exterior cover and/or body member 270 (see slide arrows) when the mobile station is folded. As a result, the ring-shaped band 211 may be removed and replaced by consumers over the folded non-hinged end of the mobile station. In another embodiment, the ring-shaped band 211′ may be slideable only to a fixed position adjacent the folded non-hinged end of the mobile station as shown, thus, maintaining the mobile station in a folded, locked position as will be apparent to one of ordinarily skill in the art.

Returning to the embodiments depicted in FIG. 5A, the ring-shaped band 211 may be configured in a variety of ways depending upon the application. In one embodiment, the ring-shaped band 211 is formed and sized to fit the perimeter of the hinge region 295 of a mobile station in the folded position. Such “fitted” ring-shaped bands 211 may apply only a nominal tension force T in the folded position. However, as will be apparent to one of ordinary skill in the art, the tension force T increases as the mobile station is opened. In various embodiments, the first and second functional components 201, 202 may be held together in the folded position by closure mechanisms such as latches, magnets, Velcro strips, or other coupling devices (not shown) provided within or attached to the first and second functional components 201, 202 as known in the art.

In other embodiments, the ring-shaped bands 211 are stretched to at least partially enclose the hinge region 295 of the mobile station in the folded position. In such “pre-stretched” embodiments, non-nominal tension forces T are applied by the ring-shaped band 211 in both the folded and open positions. The tension forces T operate as a closing force driving the first and second functional components 201, 202 together. Notably, pre-stretched embodiments may require ring-shaped bands 211 comprised of robust materials that are not unduly stressed when opened, as will be apparent to one of ordinary skill in the art.

In another embodiment, the mobile station may include an opening grip 205 providing a tactile gripping surface for assisting users when opening the mobile station 200. In one embodiment, the opening grip 205 includes opposed angularly directed lateral edges defined along at least a portion of the perimeter edges of the first and second components 201, 202 as shown. Upon un-fastening any of the optional closure mechanisms referenced above, users may open the mobile station by pressing one or more fingers into the opening grip 205 and prying the two functional components apart 201, 202, as will be apparent to one of ordinary skill in the art. In other embodiments, a user's ability to grip the first and second components 201, 202 may be enhanced by adding gripable materials, such as rubber, to the perimeter edges of the mobile station.

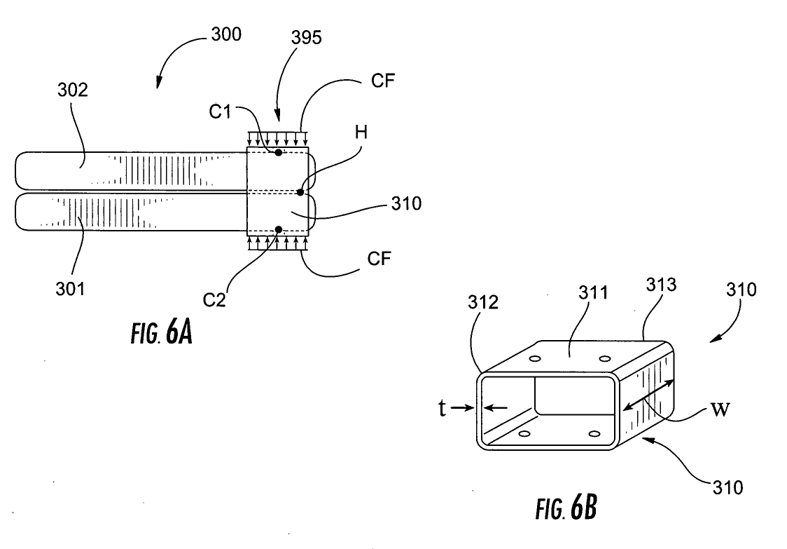

FIGS. 6-8 provide a schematic illustration of the biasing functionality performed by elastomeric tensioners 310 in accordance with several embodiments of the present invention. In pre-stretched embodiments, the elastomeric tensioner 310 applies a compressive closing force to the mobile station 300 as illustrated in FIG. 6A. The closing force drives together the mobile station's first and second functional components 301, 302, which are foldably coupled together at hinge axis H. In fitted elastomeric tensioner embodiments, such closing forces are nominal in the folded position. In the depicted embodiment, the elastomeric tensioner 310 (illustrated in further detail by FIG. 6B) is comprised of an ring-shaped band 311 that is attached to exterior surfaces (e.g., exterior cover, exterior portion of body member, etc.) of the first and second functional components 301, 302 as shown. Connection points C₁, C₂ are defined where the ring-shaped band 311 attaches to the first and second functional components 301, 302. The connection points C₁, C₂ may be single points as shown or alternatively, as suggested by the adhesively bonded elastomeric tensioners referenced above, may include a series of points along the inner contact surface of the ring-shaped band 311.

FIG. 6B is a detail illustration of the elastomeric tensioner 310 of FIG. 6A. The ring-shaped band 311 includes a first edge 312, a second edge 313, and a width w defined therebetween. As referenced above, in various embodiments the ring-shaped band 311 may be formed to fit the perimeter of the mobile station hinge or alternatively, may be mildly stretched over the mobile station hinge in the pre-stretched embodiment shown in FIG. 6A. In one embodiment, the ring-shaped band 311 includes a thickness t that is less than its width w. In other embodiments, the thickness t and width w may be generally equal. In some applications, ring-shaped bands 311 having a larger width may be preferred as they accommodate reduced material costs while ensuring a relatively broad contact surface between the ring-shaped band 311 and the enclosed mobile station 200. Further, such bands 311 allow tension forces to be distributed throughout a broader area within the band. In other applications, however, space considerations may dictate use of relatively narrow ring-shaped bands (not shown).

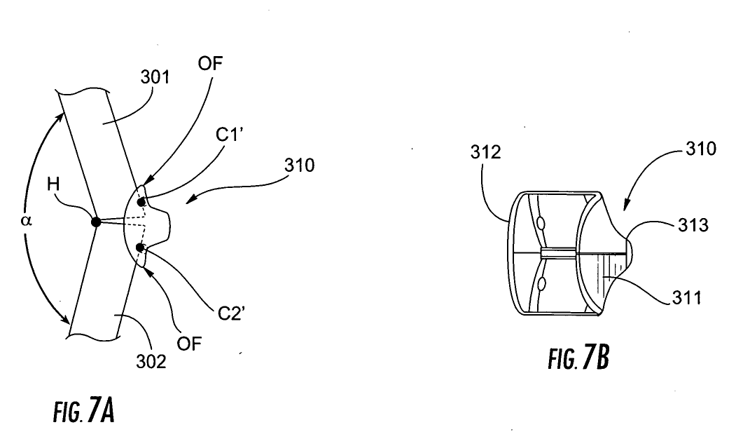

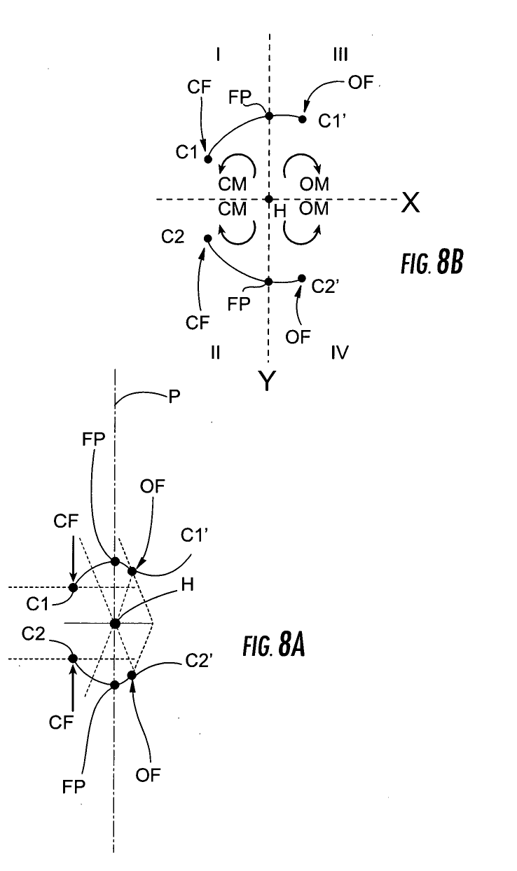

As the mobile station 300 is opened and the ring-shaped band 311 is forced into the configuration depicted in FIG. 7B, the first edge 312 of the ring-shaped band 311 is gradually stretched relative to its second edge 313 as shown. The second edge 313 of the band 311 is compressed and rotated outwardly from the exterior surfaces of the first and second functional components 301, 302 such that, in various embodiments, the second edge 313 of the band 311 loses contact with the mobile station 300. In one embodiment, the portion of the second edge 313 of the ring-shaped band 311 that extends outwardly beyond the mobile station 300 may be configured to provide a centrally-located gripping portion by which a user can manipulate hand-held mobile stations, such as a mobile phone (shown in greater detail by FIGS. 2 and 3).

As referenced above, the ring-shaped band 311 is prevented from slipping entirely off of the mobile station by couplers, hooks, flanges or other similar devices (not shown). As will be apparent to one of ordinary skill in the art, the tension force applied to the mobile station by the ring-shaped band may be modeled as a single point. In FIGS. 6A and 7A, such tension forces have been modeled to act adjacent connection points C₁, C₂ and C₁′, C₂′ respectively. Notably, depending upon the method of connection between the ring-shaped band and the mobile station, connection points may be provided at various or multiple points along the length of the band.

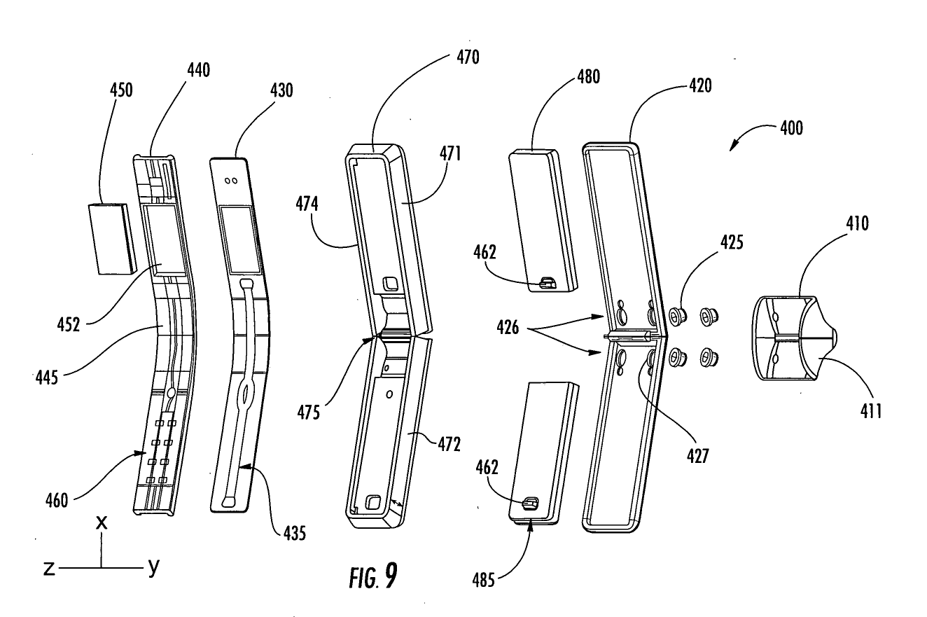

Referring to FIG. 8A, the depicted connection points travel along arcs between their folded position C₁, C₂ and their open position C₁′, C₂′. In the open position, the opening force OF operates adjacent connection points C₁′, C₂′ and is directed generally along the exterior surface of the first and second functional components 301, 302 as shown. As the mobile station 300 is opened and closed, the connection points move along the depicted travel arcs between points C₁, C₂ and C₁′, C₂′ passing over an apex position that is defined herein as a flip point FP. The flip point FP necessarily occurs along a vertical plane P extending through hinge axis H as known to one of ordinary skill in the art. As will become apparent in view of the below discussion, the tension force applied by the elastomeric tensioner may operate either as a closing force CF or an opening force OF depending on whether the mobile station is positioned before or beyond its flip point FP.

For illustration purposes, FIG. 8B divides the travel arcs of connection points C₁, C₂ into four quadrants. The quadrants are defined by coordinate axes (X, Y) that are centered along hinge axis H as shown. In quadrants I and II, the tension force applied by the elastomeric tensioner is characterized as a closing force CF because of its tendency to produce a closing force moment CM that drives the first and second functional components 301, 302 toward a folded position. In pre-stretched embodiments, the closing force moment may hold the first and second components together 301, 302, while in fitted embodiments various latches or other similar devices may be needed to hold the mobile station in a tightly folded configuration. In quadrants III and IV, the tension force applied by the elastomeric tensioner is characterized as an opening force OF, because it produces an opening moment OM that drives the first and second functional components apart. Accordingly, by rotating the opposed ends of the first and second functional components to either side of the flip point FP, a user may control whether the elastomeric tensioner biases the mobile station toward the open or the folded position.

As will be apparent to one of ordinary skill in the art, one may increase or decrease the above opening and closing moments OM, CM by increasing or decreasing the horizontal position of connection points C₁, C₂ and C₁′, C₂′ relative to hinge axis H (i.e., altering the force moment arm). For example, in one embodiment, the opening moment OM is increased over prior art devices because the hinge axis H is positioned substantially adjacent the interior surface of the mobile station while the elastomeric tensioner is coupled to the exterior surface of the first and second functional components as shown. Accordingly, a significant opening force moment OM is produced despite a preferred open position operating angle of less than 180 degrees (as shown in FIG. 7A).

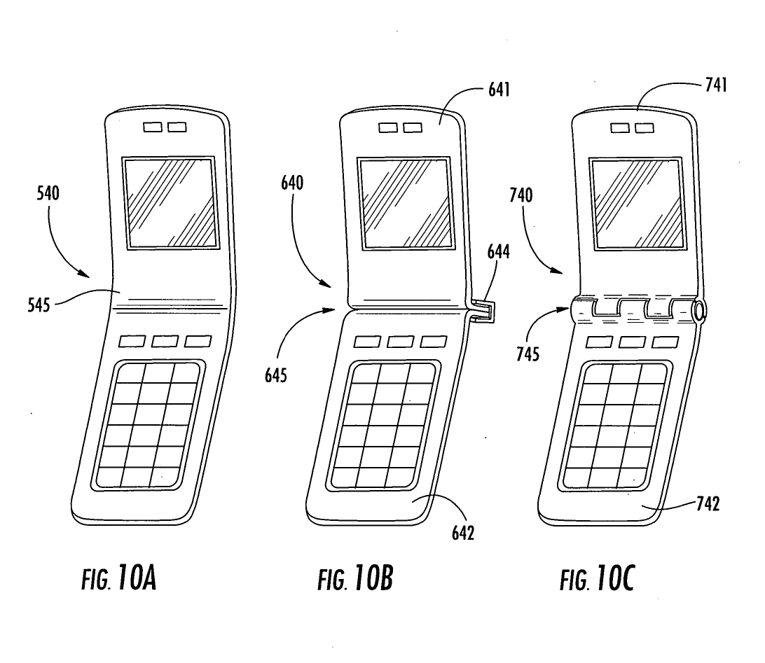

FIG. 9 illustrates an exploded view of a mobile station 400 in accordance with one embodiment of the present invention. According to the depicted embodiment, the mobile station 400 includes a user interface member 440, a communication member 430, a body 470, first and second modules 480, 485, an exterior cover 420, and an elastomeric tensioner 410. By replacing the barrel type hinge tensioner of the prior art with the external elastomeric tensioner 410 of the present invention a number of benefits may be realized. For example, the present invention significantly limits manufacturing costs by enabling z-axis assembly, wherein the x-y plane is defined generally along the plane of the user interface member as shown. According to various embodiments of the present invention, the components that combine to form a mobile station 400 (e.g., a user interface member 440, a communication member 430, body 470, a protective member 420, first and second functional modules 480, 485, etc.) may simply be stacked one atop the next during assembly as shown. In one embodiment, the first and second modules 480, 485 may include integral connectors 462 for providing electronic communication with the communication member 430, the user interface member 440 and/or other components, as known to one of ordinary skill in the art. This relatively simple process stands in sharp contrast to the intricate aligning, threading, and cable bundle wrapping operations required to produce hinge assemblies according to the known prior art. Accordingly, streamlined automated manufacturing processes can be employed to provide a more cost-effective manufactured product. In addition, the above-referenced embodiments of the present invention reduce the number and complexity of the necessary hinge components, thus, further reducing cost.

In one embodiment, the first functional component 401 is electrically connected to the second functional component 402 by a communication member 430. The communication member 430 may be comprised of a flexible electrical connector 435 as commonly known in the art. In other embodiments, however, the communication member 430 may take on other specific tasks, such as providing a receiving or transmitting antenna or facilitating various internal electronic circuitry. In these embodiments, the communication member 430 may comprise conductive leads printed on a Flexible Printed Circuit (FPC), or alternatively, may include conductors or other devices for optical transmission, inductive near field transmission or short range transmissions such as Bluetooth, RFID, 802.11 and the like.

In another embodiment, a body member 470 is provided to shield the communication member 430 and other delicate internal components against cuts, wear, hits, sharp bends etc. The body member 470 also provides structural rigidity to the mobile station as desired. The body member 470 may comprise a variety of shapes and may be composed of a variety of materials (e.g., ABS, polycarbonates, polypropylene, or other polymers, metals, composites, and the like). In one embodiment, as illustrated in FIG. 9, the body member 470 is comprised of a molded polypropylene and defines first and second portions 471, 472, separated by an integral hinge 475. In other embodiments, a non-integral hinge (not shown) may be provided for foldably coupling the first and second portions of the body member. Notably, the hinge 475 of the depicted embodiment is configured such that its pivot point is provided adjacent the interior surface 474 of the body member 470 such that the hinge axis of the mobile station may be disposed as near to the interior surface (e.g., user interface member) of the mobile station as possible.

In this regard, the design of the user interface member 440 may be further tailored to assure this interior hinged design. For example, FIGS. 10A-10C depict three user interface member embodiments having distinct hinge designs. In FIG. 10A, a flexible user interface member 540 is provided according to one embodiment. The flexible user interface member 540 transitions between open and folded positions by folding over itself in a wallet-type fashion. This embodiment not only achieves the desired interior hinge design but also provides a more compact folded position and an aesthetically pleasing “unitary” appearance to an opened mobile station. In the embodiment depicted by FIG. 10B, a book-style hinge 645 may be used. The book-style hinge 645 includes a two-part flexible user interface member 640 as shown. The first and second parts 641, 642 are clamped together in an opposed, face-to-face configuration such that each part 641, 642 is required to bend only half of the total operating angle α as shown. A variety of devices may be used to bind the first and second parts 641, 642 together including one or more clamps 644, staples, adhesives, stitches, or other binding devices known in the art. Book-style hinges may be appropriate in applications where the user interface member 640 has relatively limited flexibility. For example, some polymer materials having limited elastic flexibility may undergo undesirable plastic deformation if subjected to the full 150-180° bending range required of the “hingeless” user interface members described above. In FIG. 10C, a more conventional piano-style hinge 745 is illustrated. Advantageously, the piano-style hinge 745 of FIG. 10C is much thinner and less complex than prior art mobile station hinges because the piano hinge 745 omits the internal electrical connections and conventional tensioning devices that are necessary under the prior art.

In various embodiments of the present invention, the user interface member 540, 640, 740 may be comprised of a variety of materials. For example, the user interface member 540, 640, 740 may be wholly or partially comprised of rubber, polymer materials, metals, composites and the like. In one embodiment, a piano style hinged user interface member 740 may be comprised of a split metal frame having molded polymer inserts disposed therein to define various operational elements such as the keymat, the LED, or other similar components.

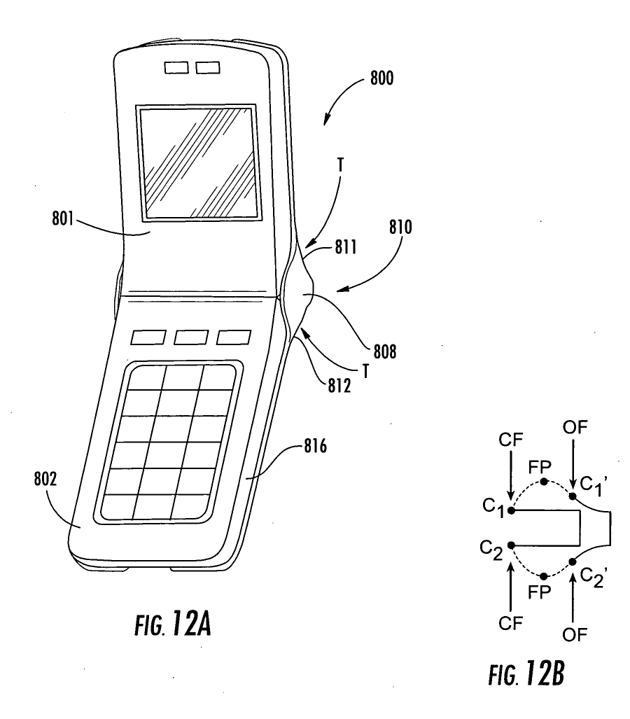

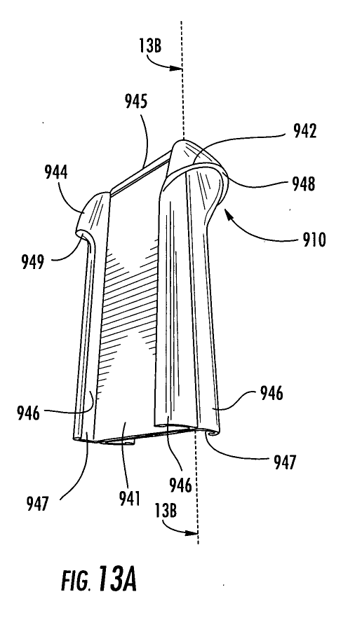

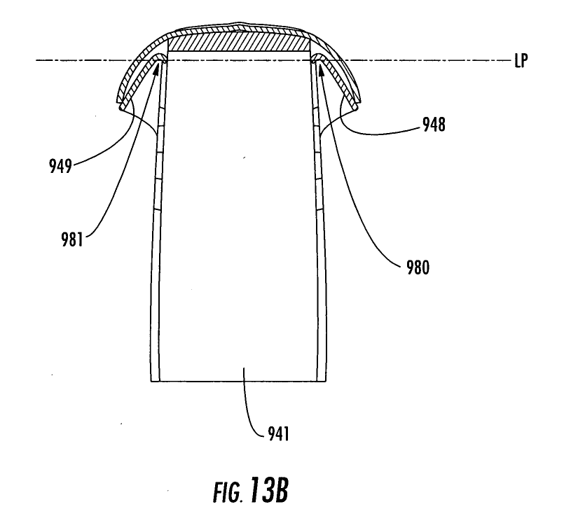

FIG. 11 illustrates an elastomeric tensioner 810 in accordance with another embodiment of the present invention. In particular, the depicted elastomeric tensioner 810 includes two opposed, inwardly directed C-shaped bands 808, 809 as shown. The C-shaped bands 808, 809 are configured to enclose the first and second components 801, 802 of the mobile station 800 adjacent the hinge region and operate quite similarly to the ring-shaped band embodiments described above. In the C-shaped band embodiments depicted in FIGS. 11 and 12, the tension force T is produced by the C-shaped member's resistance to deforming from its original pre-formed shape. This tension force T is particularly evident in view of the opened mobile station 800 illustrated in FIG. 12. As the opposed members 811, 812 of a C-shaped band 808 are driven apart by the separating first and second functional components 801, 802, the resilient C-shaped band 808 resists this separation by applying tension force T as shown. As is apparent to one of ordinary skill in the art in view of the above discussion and the schematic illustration provided by FIG. 12A, the tension force T produces either an opening or a closing force OF, CF depending on whether the mobile station has been opened or folded beyond its flip point FP.

In yet another embodiment, the ring-shaped bands or C-shaped bands of the embodiments described above may be integrally formed within the exterior cover of the mobile station. Such embodiments may be readily produced in view of the inventive concepts described herein by forming an exterior cover having a ring-shaped or C-shaped band portion of a different composition, stiffness, resiliency and/or elasticity.

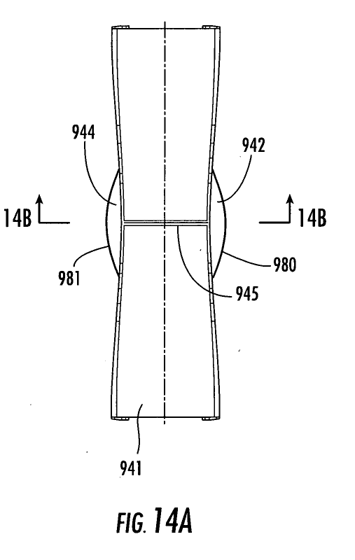

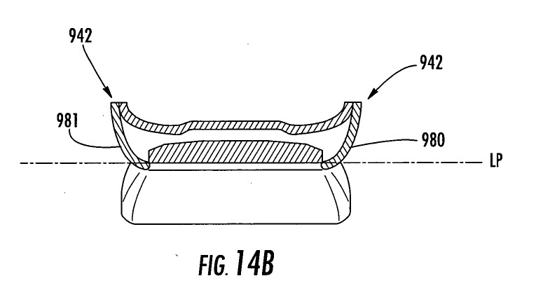

FIGS. 13-14 illustrate another elastomeric tensioner embodiment wherein the above referenced generally transversely-aligned ring-shaped bands are replaced with substantially axially-aligned bi-stable lobes. The bi-stable lobes are structurally biased toward maintaining either of two stable forms. FIGS. 13A-13C illustrate an elastomeric tensioner 910 having bi-stable lobes 942, 944 configured in a first stable form (e.g., a folded position) according to one embodiment. FIGS. 14A-14D illustrate an elastomeric tensioner 910 having bi-stable lobes 942, 944 configured in a second stable form (e.g., an open position) according to another embodiment.

To assure the bi-stable lobes apply proper biasing forces to the mobile station, the foldable body 941 must be attached to the mobile station's first and second functional components. In the embodiment depicted in FIG. 13A, coupling members 946 are provided to receive and secure the first and second functional components (e.g., the body, exterior cover, first and second modules, etc.) of the mobile station. In one embodiment, the coupling members 946 define opposed, laterally extending channels 947 as shown. These channels 947 are sized to slidably receive the first and second functional components (not shown) of the mobile station.

In the depicted embodiment, the elastomeric tensioner 910 includes a foldable body 941 (such as a user interface member) having one or more bi-stable lobes 942, 944 secured to, or formed integrally with, the foldable body 941 on either side of the hinge portion 945 as shown. In their first stable form, the bi-stable lobes 942, 944 define compact, substantially conically-shaped pockets that maintain the attached first and second functional components (not shown) substantially together. As shown in greater detail by the section view provided by FIG. 13B, each bi-stable lobe 942, 944 defines a formed edge 948, 949 and a pop-over point 980, 981 configured at the base of each conically-shaped pocket. In the depicted first stable form, the formed edges 948, 949 maintain a substantially concave shape on a first side of an imaginary lateral plane LP defined through pop-over points 980, 981.

When opened as shown in FIG. 14A, the bi-stable lobes 942, 944 deform inside-out into a second stable form wherein the lobes have an extended, relatively flattened shape that functions to maintain the attached first and second functional components 901, 902 apart. As shown in greater detail by the section view provided by FIG. 14 B, in the second stable form, the formed edges 980, 981 are transformed into an elongate generally convex shape positioned at least partially on a second side of the imaginary lateral plane LP. As referenced above, the ability of the bi-stable lobes 942, 944 to maintain two stable forms allows the foldable body 941 to define a flip position, between its open and folded positions, wherein the one or more bi-stable lobes 942, 944 apply a folding tension on a first side of the flip position and an opening tension on a second side of the flip position. In contrast to the ring-shaped or C-shaped band embodiments referenced above, the bi-stable lobes 942, 944 of the present embodiment pop or snap inside out upon reaching the flip position (proximate lateral plane LP) rather than simply deforming and, thus, may provide a relatively more dramatic opening or closing movement.

In various embodiments, although depicted in FIGS. 13 and 14 as part of an integral foldable body 941 (such as a user interface member), the bi-stable lobes 942, 944 of the present invention are not limited to such an embodiment. As will be apparent to one of ordinary skill in the art, the bi-stable lobes may be secured to, or integrally formed with, one or more axially-aligned elongate members that may be attached adjacent the lateral edges of the first and second functional components (not shown) of a mobile station.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A foldable mobile station, comprising:
a first component having interior and exterior surfaces;
a second component having interior and exterior surfaces, wherein said first component is foldably coupled to said second component via a hinge; and
an elastomeric tensioner for biasing said first and second components between open and folded positions, wherein said elastomeric tensioner engages said exterior surface of said first component and said exterior surface of said second component.

2. The foldable mobile station of claim 1, wherein:
said elastomeric tensioner is one or more continuous ring-shaped bands.

3. The foldable mobile station of claim 1, wherein:
said elastomeric tensioner includes two opposed C-shaped bands.

4. The foldable mobile station of claim 1, wherein:
said elastomeric tensioner is maintained adjacent said first and second components by first and second couplers.

5. The foldable mobile station of claim 4, wherein:
said first and second couplers are rivets.

6. The foldable mobile station of claim 5, wherein:
said first coupler includes two or more rivets and said second coupler includes two or more rivets.

7. The foldable mobile station of claim 4, wherein:
said first and second couplers include one or more adhesives.

8. The foldable mobile station of claim 4, wherein:
said first and second couplers are flanges that are configured to restrain said elastomeric tensioner from sliding along said exterior surfaces of said first and second components in a first direction and further configured to allow said elastomeric tensioner to slide along said exterior surfaces of said first and second components in a second direction.

9. The foldable mobile station of claim 1, wherein:
said elastomeric tensioner is comprised of rubber.

10. The foldable mobile station of claim 1, wherein:
said elastomeric tensioner is comprised of polymer materials.

11. The foldable mobile station of claim 1, wherein:
said elastomeric tensioner includes a contact surface that engages said exterior surface of said first component and said exterior surface of said second component substantially uniformly in said folded position, and wherein at least a portion of said contact surface of said elastomeric tensioner is disengaged from said exterior surface of said first component and said exterior surface of said second component in said open position.

12. The foldable mobile station of claim 1, wherein:
said elastomeric tensioner applies a nominal force to said exterior surface of said first component and said exterior surface of said second component in said folded position, and wherein said elastomeric tensioner applies a non-nominal force to said exterior surface of said first component and said exterior surface of said second component when said foldable mobile station is partially opened.

13. The foldable mobile station of claim 1, wherein:
said interior surface of said first component includes a foldable portion, said interior surface of said second component includes a foldable portion, and wherein a clamp is provided for capturing said foldable portion of said interior surface of said first component against said foldable portion of said interior surface of said second component.

14. The foldable mobile station of claim 1, wherein:
said interior surface of said first component, said interior surface of said second component, and said hinge combine to define an interface member.

15. The foldable mobile station of claim 14, wherein:
said interface member further comprises a keypad.

16. The foldable mobile station of claim 1, wherein:
said interior surface of said first component, said interior surface of said second component, and said hinge are integrally formed to define an interface member, and wherein said hinge is a foldable portion of said interface member.

17. The foldable mobile station of claim 16, wherein:
said interface member further comprises a keypad.

18. The foldable mobile station of claim 1, wherein:
said elastomeric tensioner is configured to at least partially enclose said first and second components adjacent said hinge.

19. The foldable mobile station of claim 1, wherein:
said elastomeric tensioner is configured to at least partially enclose opposed lateral edges of said first and second components.

20. The foldable mobile station of claim 1, wherein:
said elastomeric tensioner includes a foldable region and opposed bi-stable lobes disposed on opposite sides of the foldable region, said opposed bi-stable lobes having a first stable form for biasing the first and second components in the folded position and a second stable form for biasing the first and second components in the open position.

21. The foldable mobile station of claim 20, wherein:
at least one of the opposed bi-stable lobes define a formed edge that is generally concave in said first stable form and generally convex in said second stable form.

22. The foldable mobile station of claim 1, wherein:
said first component is configured relative to said second component to define an operating angle in said open position, and
wherein said operating angle is substantially between 90 to 180 degrees.

23. The foldable mobile station of claim 1, wherein:
said first component is configured relative to said second component to define an operating angle in said open position, and
wherein said operating angle is substantially between 150 to 180 degrees.

24. The foldable mobile station of claim 1, further comprising a communication member for electrically connecting said first component to said second component.

25. The foldable mobile station of claim 24, wherein:
said communication member includes a flexible printed circuit.

26. An elastomeric tensioner, comprising:
one or more elastic bands configured to at least partially enclose a hinge region of a mobile station, said hinge region comprising a first component foldably coupled to a second components, wherein said first and second components are at least partially separable to define an operating angle therebetween, wherein said operating angle is configurable between an open angle, a flip angle, and a folded angle; and
wherein said one or more elastic bands apply a folding tension to said first and second components when said operating angle is between said flip angle and said folded angle; and said one or more elastic bands apply an opening tension to said first and second components when said operating angle is between said flip angle and said open angle.

27. The elastomeric tensioner of claim 26, wherein:
said one or more elastic bands are continuous ring-shaped bands.

28. The elastomeric tensioner of claim 26, wherein:
said one or more elastic bands are C-shaped bands.

29. The elastomeric tensioner of claim 26, wherein:
said one or more elastic bands are comprised of rubber.

30. The elastomeric tensioner of claim 26, wherein:
said one or more elastic bands are comprised of polymer materials.

31. The elastomeric tensioner of claim 26, wherein:
said one or more elastic bands include a contact surface for engaging an exterior surface of said first component and an exterior surface of said second component substantially uniformly at said folded angle, and wherein at least a portion of said contact surface of said one or more elastic bands is disengaged from said exterior surface of said first component and said exterior surface of said second component at said open angle.

32. The elastomeric tensioner of claim 26, wherein:
said one or more elastic bands are configured to at least partially enclose opposed lateral edges of said first and second components.

33. The elastomeric tensioner of claim 26, wherein:
said operating angle is substantially between 90 to 180 degrees at said open angle.

34. The elastomeric tensioner of claim 26, wherein:
said operating angle is substantially between 150 to 180 degrees at said open angle.

35. The elastomeric tensioner of claim 26, wherein:
said operating angle is substantially between 0 to 30 degrees at said folded angle.

36. A foldable mobile station, comprising:
a first component;
a second component foldably coupled to said first component by a hinge;
an elastomeric tensioner for biasing said first and second components between open and folded positions, said elastomeric tensioner comprising:
a foldable body,
one or more laterally disposed bi-stable lobes extending from one or more edges of said foldable body adjacent said hinge, wherein said one or more bi-stable lobes each define a formed edge, wherein the formed edge defines a generally concave shape for biasing said first and second components toward said folded position and further defines an elongate generally convex shape for biasing said first and second components toward said open position.

37. The foldable mobile station of claim 36, wherein:
said first and second components define a flip position between said open and folded positions wherein said one or more bi-stable lobes of said elastomeric tensioner apply a folding force to said first and second components between said folded position and said flip position, and wherein said one or more bi-stable lobes of said elastomeric tensioner apply an opening force to said first and second components between said flip position and said open position.

38. The foldable mobile station of claim 36, wherein:
said one or more bi-stable lobes of said elastomeric tensioner are configured to provide a tactile gripping surface.

39. The foldable mobile station of claim 36, wherein:
said one or more bi-stable lobes of said lateral elastic members are comprised of a resilient polymer, said one or more bi-stable lobes form a substantially conical shape when said first and second components are in said folded position, and said one or more bi-stable lobes form an elongate generally flattened shape when said first and second components are in said open position.

40. The foldable mobile station of claim 36, wherein:
said first component includes an exterior surface and said second component includes an exterior surface; and wherein said foldable body of said elastomeric tensioner at least partially encloses said exterior surfaces of said first and second components.

41. The foldable mobile station of claim 36, wherein:
said operating angle is substantially between 90 to 180 degrees at said open angle.

42. The foldable mobile station of claim 36, wherein:
said operating angle is substantially between 150 to 180 degrees at said open angle.

43. The foldable mobile station of claim 36, wherein:
said operating angle is substantially between 0 to 30 degrees at said folded angle.

44. A hinge for foldably coupling a mobile station, the hinge comprising:
a first portion having a first folding region;
a second portion having a second folding region; and
wherein said first folding region of said first portion is captured against said second folding region of said second portion via a binding device.

45. The hinge of claim 44, wherein said binding device is a clamp.
